(19) United States
(12) Patent Application Publication
(10) Pub. No.: US 2017/0235892 A1
(43) Pub. Date: Aug. 17, 2017

(54) INCREASING VALUE AND REDUCING FOLLOW-UP RADIOLOGICAL EXAM RATE BY PREDICTING REASON FOR NEXT EXAM

(71) Applicant: Merlijn SEVENSTER, CHICAGO, IL (US)

(72) Inventor: Merlijn SEVENSTER, CHICAGO, IL (US)

(21) Appl. No.: 15/502,221

(22) PCT Filed: Aug. 11, 2015
(86) PCT No.: PCT/IB2015/056110

§ 371 Date: Feb. 7, 2017

Related U.S. Application Data
(60) Provisional application No. 62/036,143, filed on Aug. 12, 2014.

(51) Int. Cl. G06F 19/00; G06F 17/27; G06N 7/00; G06N 99/00; G06N 5/04

(52) U.S. Cl. CPC G06F 19/324; G06N 99/005; G06N 5/047; G06N 7/005; G06F 19/345; G06F 17/2785; G06F 19/321

(57) ABSTRACT

A system for predicting a reason for a patient's next exam include a clinical database storing one or more clinical documents including clinical data. A natural language processing engine processes the clinical documents to detected clinical data. A normalization engine semantically normalizes the clinical data with respect to an internal data structure and/or an ontology. A pattern recognition engine generates a mapping from a set of known reasons for exam from the normalized clinical data. A prediction engine generates a prediction for a reason for the patient's next exam.

The present application relates generally to increasing a value and reducing follow-up radiological exam rate by predicting a reason for a next radiology exam. It finds particular application in conjunction with predicting the reason for a patient's next exam based on the patient's clinical history and will be described with particular reference there. However, it is to be understood that it also finds application in other usage scenarios and is not necessarily limited to the aforementioned application.

The typical radiology workflow involves a physician first referring a patient to a radiology imaging facility to have some imaging performed. After the imaging study is performed, the radiologist interprets the images and provides one or more prognoses or treatment suggestions. During this time, the radiologist may also order additional imaging to be performed for future examinations. This could lead to numerous imaging exams being performed for each patient. Reduction of imaging exams is being incentivized by the United States government. The Affordable Care Organization mandates that care organizations receive a monetary reward per patient, not per imaging procedure. It is thus in the best interest of a care organization to reduce the number of imaging exams, while maintaining or improving the quality of care delivered.

If an interpreting radiologist could look into the clinical future of a patient, the radiologist could pay special attention to certain anatomical regions and give more relevant prognoses and treatment suggestions. This would increase the value of the radiologic examination. When clairvoyant, the radiologist could also give protocoling suggestions anticipating certain medical conditions that might arise in the future. In case a patient is hospitalized for treatment of a condition that was addressed by radiologists, the care givers (e.g. Emergency Department physicians) can benefit from it. This would reduce the number of unnecessary or incorrectly protocolled imaging exams.

The present application provides a system and method that predicts the reason for a patient's next exam based on the patient's clinical history. In addition, the system and method further integrate the predictions into the radiological interpretation workflow. The present application improves the value per imaging exam and reduces the number imaging exams per patient. The present application also provides new and improved methods and systems which overcome the above-referenced problems and others.

In accordance with one aspect, a system for predicting a reason for a patient's next exam is provided. The system includes a clinical database storing one or more clinical documents including clinical data. A natural language processing engine processes the clinical documents to detected clinical data. A normalization engine semantically normalizes the clinical data with respect to an internal data structure and/or an ontology. A pattern recognition engine generates a mapping from a set of known reasons for exam from the normalized clinical data. A prediction engine generates a prediction for a reason for the patient's next exam.

In accordance with another aspect, a system for predicting a reason for a patient's next exam is provided. The system includes one or more processors programmed to store one or more clinical documents including clinical data, process the clinical documents to detected clinical data, semantically normalize the clinical data with respect to an internal data structure and/or an ontology, generate a mapping from a set of known reasons for exam from the normalized clinical data, and generate a prediction for a reason for the patient's next exam.

In accordance with another aspect, a method for predicting a reason for a patient's next exam is provided. The method includes storing one or more clinical documents including clinical data, processing the clinical documents to detected clinical data, semantically normalizing the clinical data with respect to an internal data structure and/or an ontology, generating a mapping from a set of known reasons for exam from the normalized clinical data, and generating a prediction for a reason for the patient's next exam.

One advantage resides in predicting the reason for a patient's next exam based on the patient's clinical history

Another advantage resides improving the value per imaging exam and reducing the number imaging exams per patient

Another advantage resides in integrating predictions into the radiological interpretation workflow.

Another advantage resides in improved clinical workflow.

Another advantage resides in improved patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

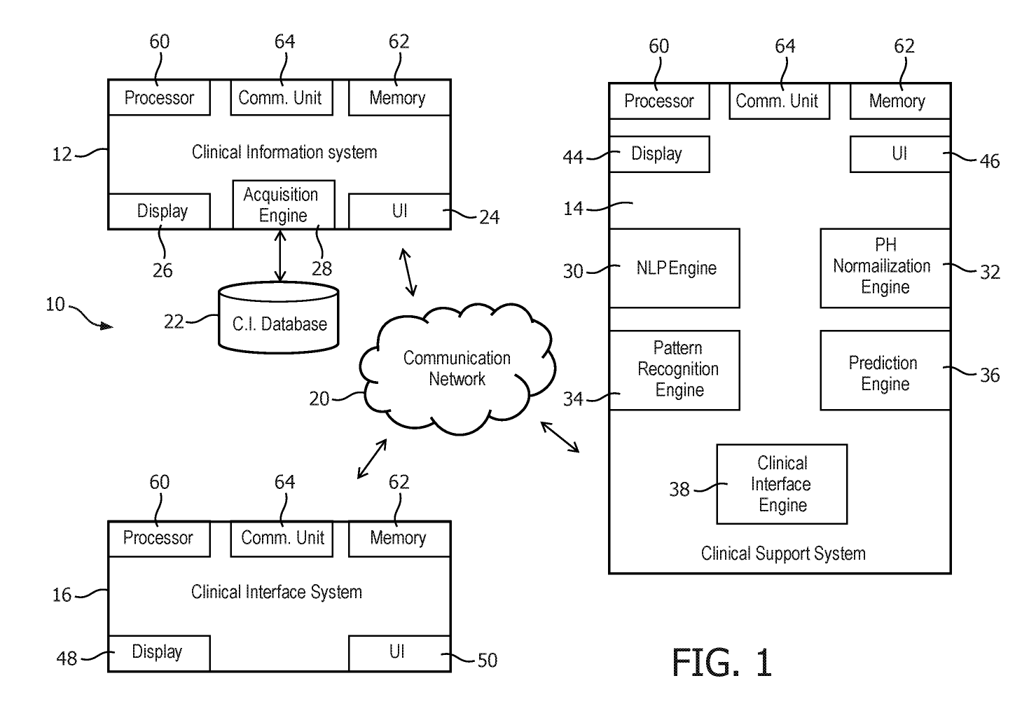

FIG. 1 illustrates a block diagram of an IT infrastructure of a medical institution according to aspects of the present application.

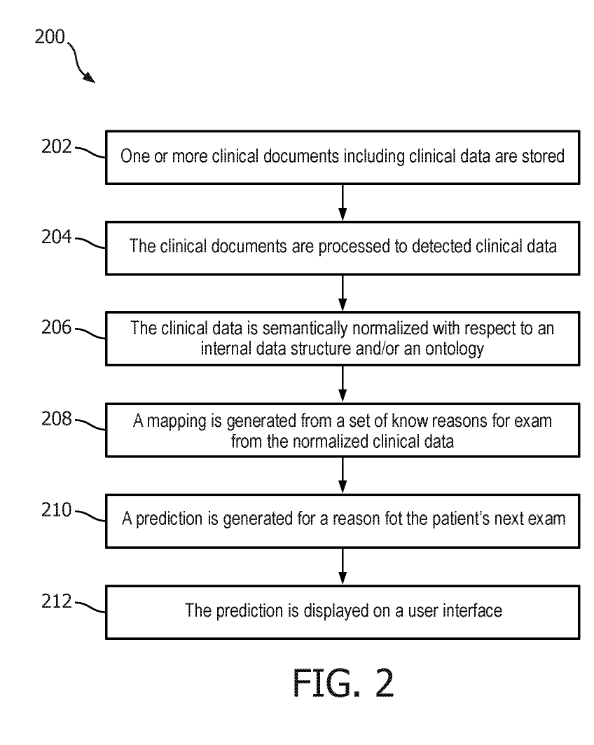

FIG. 2 illustrates a flowchart diagram of a method for predicting a reason for a patient's next exam according to aspects of the present application.

Reduction of imaging exams is being incentivized by the U.S. government (e.g., the Affordable Care Organization initiative). If an interpreting radiologist could look into the clinical future of a patient, the radiologist could pay special attention to certain anatomical regions and give more relevant prognoses and treatment suggestions. The present application predicts the reason for a patient's next exam based on the patient's clinical history. In addition, the predictions are integrated into the interpretation workflow. The present application improves the value per imaging exam and may reduce the number imaging exams.

With reference to FIG. 1, a block diagram illustrates one embodiment of an IT infrastructure 10 of a medical institution, such as a hospital. The IT infrastructure 10 suitably includes a clinical information system 12, a clinical support system 14, a clinical interface system 16, and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The clinical information system 12 stores clinical documents including radiology reports, medical images, laboratory reports, lab/imaging reports, electronic health records, EMR data, and the like in a clinical information database 22. A clinical document may comprise documents with information relating to an entity, such as a patient including pertinent patient health information such as dated reasons for exam of radiology exams. Some of the clinical documents may be free-text documents, whereas other documents may be structured document. Such a structured document may be a document which is generated by a computer program, based on data the user has provided by filling in an electronic form. For example, the structured document may be an XML document. Structured documents may comprise free-text portions. Such a free-text portion may be regarded as a free-text document encapsulated within a structured document. Consequently, free-text portions of structured documents may be treated by the system as free-text documents. Each of the clinical documents contains a list of information items. The list of information items including strings of free text, such as phases, sentences, paragraphs, words, and the like. The clinical information system 12 also includes an electronic patient history acquisition engine 28 which accesses clinical information database 22 and stores obtained information in a manner that is accessible to other engines. The data acquisition component of this engine 28 can be implemented using known API techniques. The patient health information is generally stored in the clinical information database 22 that has an API for reading and writing clinical information. Such EHRs can generally be queried for all clinical documents pertaining to a patient-specific Medical Record Number (MRN). The acquisition engine 28 has an appropriate data structure for storing the data acquired. In addition to storing the documents itself (either as free text or as a table of structured values), it has fields for identifying the source (e.g., radiology, lab or pathology) and date of each document, as well as relations between documents. The information items of the clinical documents can be generated automatically and/or manually. For example, various clinical systems automatically generate information items from previous clinical documents, dictation of speech, and the like. As to the latter, user input devices 24 can be employed. In some embodiments, the clinical information system 12 include display devices 26 providing users a user interface within which to manually enter the information items and/or for displaying clinical documents. In one embodiment, the clinical documents are stored locally in the clinical information database 22. In another embodiment, the clinical documents are stored nationally or regionally in the clinical information database 22. Examples of patient information systems include, but are not limited to, electronic medical record systems, departmental systems, and the like.

The clinical support system 14 utilizes natural language processing and pattern recognition to detect relevant patient health information within the clinical documents. The clinical support system 14 also semantically normalizes the contents of a given set of patient health information with respect to an internal data structure and/or an ontology that comprehensively describes the medical domain. The clinical support system 14 also trains on sets of semantically normalized patient health information, and (b) queries the patient health information to predict reason for future exam given a set of semantically normalized patient history. When queried, the clinical support system 14 returns a mapping from the set of known reasons for exam to pertinent information, such as likelihood and time interval (“within 8 weeks”). The clinical support system 14 also presents the predictions from the pattern recognition engine to the interpreting radiologist. The clinical support system 14 includes a display 44 such as a CRT display, a liquid crystal display, a light emitting diode display, to display the information items and user interface and a user input device 46 such as a keyboard and a mouse, for the clinician to input and/or modify the provided information items.

Specifically, the clinical support system 14 includes a natural language processing engine 30 which processes the clinical documents to detect information items in the clinical documents and to detect a pre-defined list of pertinent clinical findings and patient health information. To accomplish this, the natural language processing engine 30 segments the clinical documents into information items including sections, paragraphs, sentences, words, and the like. Typically, clinical documents contain a time-stamped header with protocol information in addition to clinical history, techniques, comparison, findings, impression section headers, and the like. The content of sections can be easily detected using a predefined list of section headers and text matching techniques. Alternatively, third party software methods can be used, such as MedLEE. For example, if a list of pre-defined terms is given (“lung nodule”), string matching techniques can be used to detect if one of the terms is present in a given information item. The string matching techniques can be further enhanced to account for morphological and lexical variant (Lung nodule=lung nodules=lung nodule) and for terms that are spread over the information item (nodules in the lung=lung nodule). If the pre-defined list of terms contains ontology IDs, concept extraction methods can be used to extract concepts from a given information item. The IDs refer to concepts in a background ontology, such as SNOMED or RadLex. For concept extraction, third-party solutions can be leveraged, such as MetaMap. Further, natural language processing techniques are known in the art per se. It is possible to apply techniques such as template matching, and identification of instances of concepts, that are defined in ontologies, and relations between the instances of the concepts, to build a network of instances of semantic concepts and their relationships, as expressed by the free text.

The clinical support system 14 also includes a patient history normalization engine 32 that semantically normalizes the contents of a given set of patient health information with respect to an internal data structure and/or an ontology that comprehensively describes the medical domain. Segmentation of the clinical documents pertains to structuring it in terms of functional components that are generally readily observed from the document's layout. For instance, lab reports generally consist of a list of variable-value pairs. On the other hand, radiology and pathology reports typically have a section-paragraph-sentence structure. For each clinical document (e.g., lab, radiology or pathology), the segmentation engine 14 segments the clinical documents in appropriate parts. Such segmentation engines can be constructed using lexical pattern recognition and/or machine classification techniques. For instance, detecting variable-value pairs is straightforward and can be done by means of regular expressions (lexical pattern recognition). On the other hand, determining the end of sentence in a free-text report is generally harder due to ambiguity of the dot character. For instance, in “Dr. Doe” and “2.3 cm”, the dot does not mark an end of sentence. Such ambiguities can be resolved by machine learning techniques such as maximum entropy (machine classification).

Once segmented, information items can be semantically normalized depending on their nature. In a variable-value, the variable can be mapped onto a list of known lab variables using straightforward string matching techniques. In a free-text sentence from a radiology report, concepts can be extracted and mapped onto a comprehensive medical ontology. Concept extraction techniques have been studied in the scientific literature. MetaMap, made available by the NIH, seems to be the de facto standard in the field of medical language processing. It detects phrases in a sentence and whether they are negated. Third-party (e.g., MedLEE) or home-grown solutions can also be used to support concept extraction. A SNOMED concept represents an entity in the medical domain, such as a diagnosis, symptom or procedure. SNOMED has several relations that interconnect concepts, which allow for hierarchical, anatomical and causal reasoning. Hierarchical reasoning allows for filtering information in documents. In this manner we can select all signs and symptoms (“cough”) or event (“drug overdose”) concepts from a reason for exam and discard patient background concepts (“HIV positive”).

In particular, analysis of reasons for exam section of the clinical documents is important. Reasons for exams are generally short pieces of text entered by the referring clinician describing the patient's history and symptoms as well as clinical question(s) that motivate the examination. Pressed for time, referring clinicians generally use abbreviations. Lexical techniques can be used to expand abbreviations. Oftentimes, however, an abbreviation can have multiple meanings. In that case, disambiguation techniques need to be used that use the syntactical context of the abbreviation (i.e., the sentence in which it appears or noun phrases and verbs found in the reason for exam) as well as its source (i.e., radiology report). A disambiguation engine can be devised using rule-based or machine learning techniques.

The clinical support system 14 also includes a pattern recognition engine 34. After semantic normalization, the pattern recognition engine 34 characterizes the clinical document as a (long) series of atomic and compound variables. For instance, the pattern recognition engine 34 includes an atomic variable marking the gender of the patient and a compound variable indicating if the patient has been diagnosed with HIV. If the patient has been diagnosed as HIV positive, this variable also contains the date of diagnoses. Being a short document, reasons for exam can be considered as a series of variables as well.

Perceived as vectors of semantically normalized variables, statistical methods can be used to detect dependency patterns in patient histories between patient demographics, events, prior diagnoses, medical interventions and other types of clinical conditions on the one hand, and reasons for exam on the other hand. The pattern recognition engine 34 is interested in dependency patterns that bridge a certain time interval: e.g., given a known condition of HIV and a current X-ray, there is a 60% chance that the patient will represent with cough and abdominal pain within 8 weeks from the current examination.

Some variables may be overly specific and may thus need to be generalized. For instance, to this end, we can introduce time interval bins (e.g., “last week”, “last month”, “more than two years ago”). Extracted concepts can be generalized using the ontology's hierarchical relation between concepts (e.g., “laryngeal cancer” → “head and neck cancer” → “cancer”). It is conceivable that dependencies are found on general levels that cannot be found on more specific levels of abstraction. For instance, there may be a dependency pattern between abdominal cancers and HIV on the one hand and cough on the other hand, whereas there is no or insufficient evidence to support a dependency pattern for renal cancer and HIV. Detection of dependency patterns can be done in an offline mode using all or a selection of patient health information records. The result of this offline processing effort is a statistical model in which the likelihoods of reasons for future exams are estimated given a patient's history and current presentation.

The pattern recognition engine 34 can be queried by first converting the patient health information records of a patient into a vector of normalized variables. The resulting vector is then handed over the statistical model, which returns a list of reasons for future exams. Depending on its implementation, we can assign a likelihood value to each reason for exam and time interval. Thus, the likelihood of a patient present with cough within one week may be set to 5%, whereas it may be 25% if the time interval is one month.

The clinical support system 14 also includes a prediction presentation engine 36 which predicts the reason for a patient's next exam. When interpretation of an image exam starts, the patient history and reason for current exam is available to the system. This information is normalized and converted to a variable vector and subsequently handed over to the pattern recognition engine. The result is a mapping from known reasons for exam to pertinent information, such as likelihood and time span.

The mapping can be condensed by ordering the reasons for exam by likelihood. In case the mapping contains not only likelihood but also time span information (“likelihood is 5% within next week; 25% within next month”), a weighted aggregated likelihood can be computed (“overall likelihood is 15%”), which is then used for ordering reasons for exam.

The most likely reasons for exam can be displayed to the user as a list via a user interface. It is conceivable that time span information is suppressed in the base presentation via a clinical interface engine 38. When the user clicks a listed reason for future exam, additional information may be displayed showing the likelihood over pertinent time spans. Alternatively, the user may be able to select a certain time span, which acts as a filter on the mapping, effectively re-ordering the reasons for future exam, based on their likelihood in the selected time spans. It is further conceivable that the presentation be made dynamic, so that the user can add and delete variables to see their impact on the prediction suggestions. This can be done using standard visual techniques.

The clinical interface system 16 displays the user interface that enables the user to view the prediction the reason for a patient's next exam based on the patient's clinical history and the most likely reasons for exam. The clinical interface system 16 receives the user interface and displays the view to the caregiver on a display 48. The clinical interface system 16 also includes a user input device 50 such as a touch screen or keyboard and a mouse, for the clinician to input and/or modify the user interface views. Examples of caregiver interface system include, but are not limited to, personal data assistant (PDA), cellular smartphones, personal computers, or the like.

The components of the IT infrastructure 10 suitably include processors 60 executing computer executable instructions embodying the foregoing functionality, where the computer executable instructions are stored on memories 62 associated with the processors 60. It is, however, contemplated that at least some of the foregoing functionality can be implemented in hardware without the use of processors. For example, analog circuitry can be employed. Further, the components of the IT infrastructure 10 include communication units 64 providing the processors 60 an interface from which to communicate over the communications network 20. Even more, although the foregoing components of the IT infrastructure 10 were discretely described, it is to be appreciated that the components can be combined.

With reference to FIG. 2, a flowchart diagram 200 of a method for predicting a reason for a patient's next exam is illustrated. In a step 202, one or more clinical documents including clinical data are stored. In a step 204, the clinical documents are processed to detected clinical data. In a step 206, the clinical data is semantically normalized with respect to an internal data structure and/or an ontology. In a step 208, a mapping is generated from a set of known reasons for exam from the normalized clinical data. In a step 210, a prediction is generated for a reason for the patient's next exam. In a step 212, the prediction is displayed on a user interface.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for predicting a reason for a patient's next exam, the system comprising:
a clinical database storing one or more clinical documents including clinical data of the patient;
a natural language processing engine which processes the clinical documents to detect the clinical data;
a normalization engine which semantically normalizes the clinical data with respect to an internal data structure and/or an ontology;
a pattern recognition engine which generates a mapping from a set of known reasons for exam from the normalized clinical data; and
a prediction engine which generates a prediction for a reason for the patient's next exam from the mapping.

2. The system according to claim 1, wherein the pattern recognition engine is trained on sets of semantically normalized clinical data, and is queried to predict reason for future exam given a set of semantically normalized patient history.

3. The system according claim 1, further including:
an clinical interface engine which generates a display including the prediction for a reason for the patient's next exam.

4 . The system according to claim 1, wherein the mapping includes at least one of the likelihood for the reasons for exam and time span information.

5. The system according to claim 1, wherein the mapping is performed utilizing the clinical data and a statistical model.

6. The system according to claim 1, wherein the user interface include at least one of additional information displayed showing the likelihood over pertinent time spans.

7. The system according to claim 1, wherein user interface enables the user to add and delete variables to see impact on the prediction, which triggers re-computation of the prediction based on the new set of variables.

8. (canceled)

9. (canceled)

10. (canceled)

11. (canceled)

12. (canceled)

13. A method for predicting a reason for a patient's next exam, the method comprising:
storing one or more clinical documents including clinical data of the patient;
processing the clinical documents to detect the clinical data;
semantically normalizing the clinical data with respect to an internal data structure and/or an ontology;
generating a mapping from a set of known reasons for exam from the normalized clinical data; and
generating a prediction for a reason for the patient's next exam from the mapping.

14. The method according to claim 13, further including:
generating a display including the prediction for a reason for the patient's next exam.

15. The method according to claim 13, wherein the mapping includes at least one of the likelihood for the reasons for exam and time span information.

16. The method according to claim 13, wherein the user interface include at least one of additional information displayed showing the likelihood over pertinent time spans.

17. The method according to claim 15, wherein user interface enables the user to add and delete variable to see impact on the prediction.
